(19) United States
(12) Patent Application Publication
(10) Pub. No.: US 2011/0078210 A1
(43) Pub. Date: Mar. 31, 2011

(54) SYSTEM AND METHOD FOR HANDLING VALIDITY-DEPENDENT DATA SETS

(75) Inventor: Winfried Schwarzmann, Waghaeusel (DE)

(73) Assignee: SAP AG, Walldorf (DE)

(21) Appl. No.: 12/566,917

(22) Filed: Sep. 25, 2009

(51) Int. Cl. G06F 17/30

(52) U.S. Cl. 707/803; 707/E17.044; 707/E17.002; 707/E17.107

(57) ABSTRACT

A system and method to generically handle validity dependent data sets. A set of dimensions applicable to the data set is defined. At least one dimension is associated with a validity independent structure of the data set and at least one other dimension is associated with a validity constraint effective for the data set. The data set is retrieved with its associated dimensions. A model of the data set is created using the associated dimensions. The model provides access to the data in a manner that permits it to be viewed and manipulated to respond to requests of a consuming application.

### BACKGROUND OF THE INVENTION

1. Field

Embodiments of the invention relate to data handling. More specifically, embodiments of the invention relate to modeling and manipulation of validity dependent data sets.

2. Background

Typically, a validity dependent data set includes an arbitrarily large number of data objects and the relations between them. The validity dependency of an object is represented by one or more states of the object where the validity of each state is constrained by values of one or more validity parameters. One example of a validity parameter is time. As such, the state of an object may be valid at one time, but no longer valid after that time has passed. Other parameters, such as serial number, for example, may also serve as a validity parameter.

Handling a validity dependent data set requires providing a valid view of the data set to a consuming application based on a set of parameters provided by the consuming application. Often the set of parameters provided constrain both the structure and the validity of the underlying data set.

Generically handling validity dependent data sets is problematic at least in part as a result of the large diversity of underlying data models. For example, not all objects are validity dependent, that is, not all objects may have multiple states. In some cases, relations between objects may themselves be validity dependent. A state of an object may change even after additional states of the object have been added to the model. Validity dependency may result from versioning of entire components as well as delta tracking on object or even object feature level. The domain of a validity parameter is not necessarily continuous or sorted, and in some cases may be a discrete and unsorted value set. Therefore, the states of an object cannot necessarily be sequenced based on their validity constraints. Some objects in the data model may be autonomous, while other objects in the data model depend on the preexistence of still other objects to which they are related. Additional consuming applications may desire the data in a format different from the format of the underlying data model. In light of this non-exhaustive list of diversity characteristics, no tools currently exist for handling arbitrary validity dependent data sets.

### SUMMARY OF THE INVENTION

A system and method to generically handle validity dependent data sets is disclosed. A set of dimensions applicable to the data set is defined. At least one dimension is associated with a validity independent structure of the data set and at least one other dimension is associated with a validity constraint effective for the data set. The data set is retrieved with its associated dimensions. A model of the data set is created using the associated dimensions. The model provides access to the data in a manner that permits it to be viewed and manipulated to respond to requests of a consuming application.

### BRIEF DESCRIPTION OF DRAWINGS

The accompanying drawings, which constitute a part of this disclosure, illustrate various embodiments and aspects of the present invention and, together with the description, explain the principles of the invention.

FIG. 1 is a block diagram of a system of one embodiment of the invention.

FIGS. 2A and 2B are a flow diagram of operation in one embodiment of the invention.

FIG. 3 is a diagram focusing on the mapping of object state elements to index elements within a model of a validity dependent data set which has been generated consistent with one embodiment of the invention.

FIG. 4 is a diagram focusing on relation state elements, and their substitution, within an additional model of a validity dependent data set according to one embodiment of the invention.

FIG. 5 is a dimensional diagram showing exemplary assignment of object states to two validity dimensions.

### DETAILED DESCRIPTION

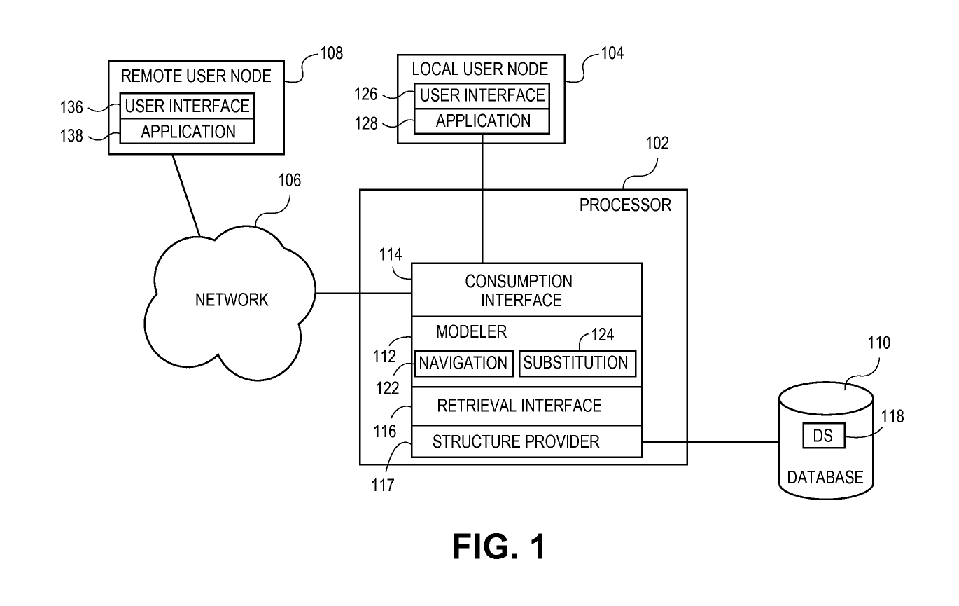

FIG. 1 is a block diagram of a system of one embodiment of the invention. A processor 102 is coupled to a database 110 that may store a validity dependent data set 118. Processor 102 may also be coupled to a local user node 104 and/or via a network 106 to a remote user node 108. Local user node 104 has user interface 126 which permits a user to select parameters at a consuming application 128 that application 128 transforms into a request having a set of constraints to be applied to data set 118. Similarly, remote user node 108 includes user interface 136 that permits a user to give input that application 138 transforms into a request for a change on data set 118.

Processor 102 provides a standard consumption interface 114 to which applications 128, 138 may issue requests to handle data set 118. For example, the applications 128, 138 may request particular views of the data set. Processor 102 also provides a standard retrieval interface 116. In some embodiments, the retrieval interface is implemented by a structure provider 117 which loads data set 118 from a persistent storage such as database 110 and associates it with a set of dimensions. In other embodiments, the data set may be transmitted directly to the retrieval interface 116 from a remote system using a protocol based on the association of the data set with a set of dimensions.

Master data includes a structure consisting of data objects and relations that are defined between those objects. In addition, master data may include components containing these objects and relations. The processor 102 requires that the master data is associated to a set of dimensions so that different dimensions are defined to express the structure and the validity dependency of the master data, respectively. The dimensions can be defined at runtime, in one embodiment by structure provider 117, but customizing based on certain types of data sets is also contemplated as within the scope of the invention. The association of the data set to the dimensions may be either stored with the master data in the database, or added at runtime by structure provider 117. In the first case, the database tables may be defined according to a generic design pattern for validity dependent master data in accordance with one embodiment of the invention. In some embodiments, the data set 118 is stored in a file using a tag-based markup language such as extensible markup language (XML). The set of tags can be used to associate the data with the set of dimensions.

In one embodiment, a structural dimension may be defined for each hierarchical or sequential validity independent structure of the data set, and a validity dimension may be defined for each validity parameter of which at least one validity constraint is effective for the data set. For example, in some cases the data set may represent an engineered product. In such cases, the structural dimension of the data may correspond to a hierarchical composition structure or a sequential routing structure of the product. For example, a validity dimension may be defined for each validity parameter used by a change management system. Modeler 112 accesses retrieval interface 116 to get this master data and to generate a plural dimensional model of the data set in the “space” spanned by the associated structural and validity dimensions.

The modeler 112 includes a navigation module 122 and a substitution module 124 which respectively permit navigation around the plural dimensional model as well as substitution of one model element for one or multiple more elementary model elements. Navigation and substitution are discussed in further detail below.

The modeler 112 is responsible for creating the model in the space defined by the set of dimensions associated with the data set 118. Each dimension has arbitrarily many indices. Graphically, an index may be represented by a location along an axis corresponding to a dimension.

An index is uniquely assigned to a dimension. An index of a structural dimension represents the validity independent existence of an object. An index of a validity index represents the beginning or end of a validity constraint. In most cases, the end of a validity constraint coincides with the beginning of another.

In some embodiments, semantically related indices can be combined into a “range.” A range is uniquely assigned to a dimension. For example, a range of a hierarchy dimension may combine a leaf object of one component with a root object of another component to enable multi-level views. As used herein “component” refers to a group of tightly related objects, such as a header and position objects from a bill of material. A range of a validity dimension may combine, for example, all indices representing the same validity value as part of multiple changes. This reflects current procedure in engineering, where all changes during the product design phase become effective on the start-of-production (SOP), the day on which the official handover to manufacturing takes place. To keep the changes distinct, this method defines different validity indices which all represent the SOP time. However, a range defined for all these indices allows efficient simplification whenever wanted.

Structure provider 117 assigns indices to the objects and validity constraints. The states of an object have a correspondence to both the index representing the object as well as to one or multiple validity indices representing the validity constraints of these states. Therefore, it is defined at the intersection of the index layers in the space spanned by the structural and validity dimensions. There may be arbitrarily many states defined within the space. Because indexes are defined to be unique within a dimension, the intersection between the indices of two dimensions is also unique. Thus, each state occupies a unique position within a layer of the model. In one embodiment, the coordinates resulting from these intersections are represented as points in a plural dimensional partially ordered space.

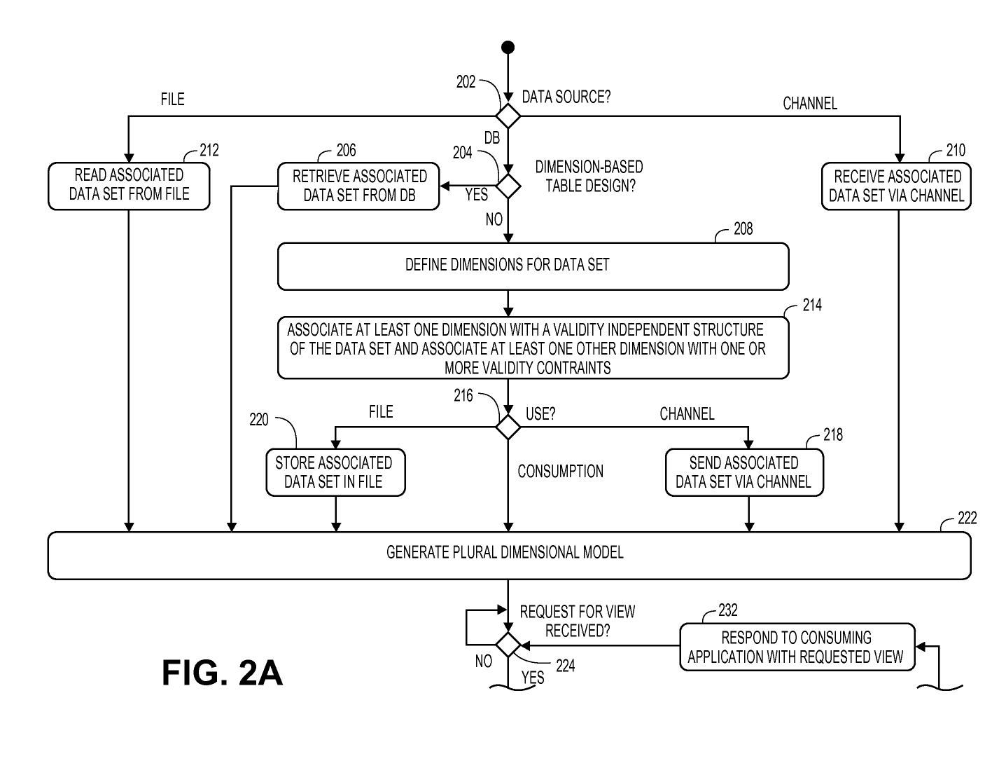

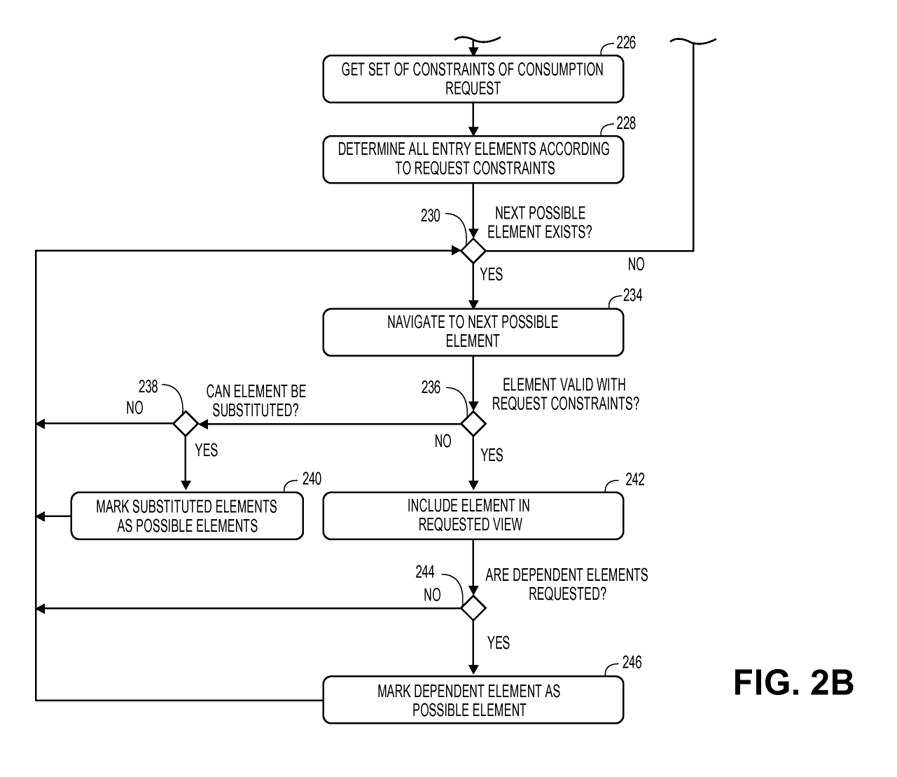

FIG. 2 is a flow diagram of operation in one embodiment of the invention. At decision point 202, the location of the validity dependent data set is determined. If a file is given, then this file contains the data set and its association to a set of dimensions, for example, based on a tag-based markup language such as extensible markup language (XML). At block 212, the processor 102 loads this file for generating a model at block 222. If a channel to a remote system is given, then this channel provides a protocol for transmitting the data set and its association to a set of dimensions. At block 210, the processor 102 triggers the transmission for generating a model at block 222. If an access to a coupled database 110 is given, then this access is checked at decision point 204 whether or not the corresponding persistence is in accordance with a design pattern where a validity dependent data set is stored together with its association with a set of dimensions. In case of accordance, the processor 102 accesses database 110 at block 206 for generating a model at block 222.

In the other case, at block 208, structure provider 117 accesses database 110 and defines a set of dimensions for the read data set. This set of dimensions may include one or multiple structural dimensions and one or multiple validity dimensions. For example, there may be a structural dimension for the representation of a product composition by super- and subordinate bills of materials, another structural dimension for the representation of the corresponding production plan by preceding and succeeding operations and activities, and a validity dimension for each validity parameter in use by the change management. At block 214, structure provider118 associates at least one dimension with the validity independent structure of the data set and at least one other dimension with the validity constraints of the data set. In one embodiment, the validity independent structure of the data set includes objects of one or multiple aspects and relations between those objects of one or multiple aspects. As used herein, an “aspect” is a common data format, i.e. same data fields. The validity independent structure of the data set may further include components of one or multiple aspects, a component containing objects and relations. Optionally, the validity independent structure of the data set includes features of one or multiple aspects, a feature being a subordinate characteristic to an object, a relation, a component or another feature. For example, an instance of a feature could be a computer aided design (CAD) drawing.

Then, at decision point 216, processor 102 checks the intended use of the data retrieval. In one embodiment, there may be multiple usages simultaneously wanted. If a file name is given, then the retrieved data is stored in this file at block 220, for example, using the corresponding XML tags. If a channel is given, then the retrieved data is sent off using a corresponding protocol at block 218. If a consuming application is given, then the modeler 112 generates a plural dimensional model at block 222. This model generation comprises at least creating an element for each dimension, each index, each object state, each relation state, etc. As used herein, “element” refers to a constituent part of the model.

Once the model exists, a determination is made at decision point 224 whether a request for one or more elements of the model has been received. As previously noted, consuming applications send requests with a specified set of constraints to be applied to the data set. The modeler is then responsible for either returning elements that represent a view of the model subject to those constraints or changing elements of the model in correspondence to those constraints. In the following, the flow of operation is explained specifically for view requests. Such requests may include constraints such as an index for each validity dimension to receive a particular state of the entire structure of the data set. Additional constraints like a list of components or the maximum depth of the structure limit the returned view to a particular substructure thereof. If request constraints refer to identities and/or aspects for some element types, then the returned elements of one of these types must have one of the respective identities or aspects. With respect to the flow of operation in FIG. 2, at block 226, the processor 102 gets the request constraints. In one embodiment, it determines at block 228 all possible entry elements into the model according to these request constraints.

In the following, at decision point 230, the processor 102 checks whether a next possible element is available. If none is available, then the processor 102 responds at block 232 to the consuming application with the requested elements (desired view) and awaits further requests. If a next possible element is available, then the navigation module 122 accesses this element at block 234. The navigation module 122 is designed to allow navigation directly or indirectly to all elements of the model. It can navigate: from an index to an assigned dimension and from a dimension to at least the root and the leaf indices in the associated network; between two indices based on a link defined between them; between states and indices for which a mapping has been defined; and between the object or object states which are involved in a relation or relation state.

At decision point 236, the processor 102 checks whether or not this next possible element is valid according to the request constraints. If it is valid, then it is a requested element and will be part of the eventual response as described above (block 242). At decision point 244, a determination is made whether or not there are dependent elements of the considered element. A dependent element may be a related object state or a subordinate feature state. The dependent elements are marked as possible elements at block 246. After that the decision point 230 is reached again.

If the considered element is not found valid at decision point 236, then it is checked at decision point 238 whether or not this element can be substituted based on a hierarchical property of the data set. This substitution yields a set of elements which are marked as possible elements at block 240. After that the decision point 230 is reached again.

In one embodiment, substitution module 124 allows substitutions of: a component by all objects and relations contained by it; a dimension by all indices assigned to it; an index by all states mapped to it; a link by all states mapped to it; and a relation state involving at least one object by derived relation states at least resulting from substituting the object by all its object states. Sometimes constraints in the request limit the substitution that is permitted. In some cases, navigation and substitution may be used in conjunction. For example, substitution may yield an element which has been accessed using navigation.

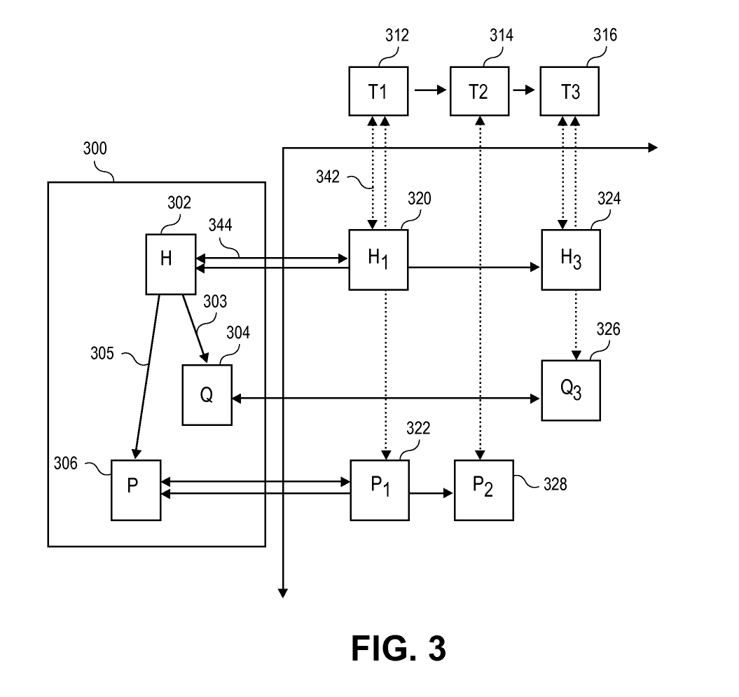

FIG. 3 is a diagram focusing on the mapping of object state elements to index elements within a model of a validity dependent data set which has been generated consistent with one embodiment of the invention. In this diagram, a validity dimension is depicted as the horizontal axis and the structural dimension is depicted as the vertical axis. The validity independent structure of the data set consists of the objects H 302, Q 304 and P 306 as well as the relations 303 and 305. It may represent a bill of material (BOM) with one material H 302 being the result of assembling two materials Q 304 and P 306. A component 300 representing this BOM contains the three objects and the two relations mentioned above. The aspect of the BOM header H 302, e.g. comprising a data field for the relevant plant, is different from the common aspect of the BOM positions Q 304 and P 306, e.g. including the assembled amount and the unit of measure. The assignment of a describing document could be a feature of the BOM header and the BOM position. The result of associating the structural dimension with this validity independent structure is a network comprising three indices for the objects and two directed links for the relations.

The validity dimension may represent the continuous domain of a validity parameter like the time. The validity constraints, which are effective for the data set, have the points in time T1 312, T2 314 and T3 316 as bounds and result in the validity time periods [T1,T2), [T2,T3) and [T3,+). The result of associating the validity dimension with these validity constraints is a network comprising three indices for the points in time and two directed links for the chronological order among them. In one embodiment, an index in the validity dimension may represent a tuple of bounds of validity constraints, e.g. a time and a serial number.

The validity dependent part of the data set comprises two states H1 320 and H3 324 of object H 302, one state Q3 326 of object Q 304 and two states P1 322 and P2 328 of object P 306. The association of the structural dimension further comprises that each of these object states is mapped to the index representing its object. For example, object state H1 320 is mapped to the index representing object H 302, in short, index 302. This mapping allows the navigation module (122 of FIG. 1) to get from this object state element to this index element, and vice versa. The association of the validity dimension further requires that each of these object states is mapped to at least the index representing the beginning of its validity period. For example, object state H1 320 is mapped to index T1 312. Similarly, this mapping allows the navigation module to get from this object state element to this index element, and vice versa. Mapping the object state H1 320 to the index T3 316 representing the respective end is redundant as this end coincides with the beginning of the validity period of its successor state H3 324. The mapping of object states to indices can either be defined explicitly or implicitly, in FIG. 3 distinguished by solid or dotted bidirectional arrows, respectively. From FIG. 1 the modeler 112 retrieves the explicit mapping between object states and structural indices by means of a mapping table as part of the retrieval interface 116. Whereas it retrieves the implicit mapping between object states and validity indices by validity index identifiers stored in additional data fields in the object state aspects. In this model, the relations are not validity dependent, and therefore are valid whenever a state of its parent object and a state of its child object is valid. For example, in the time period [T1,T2) not only the object states H1 320 and P1 322, but also the derived relation between them is valid. Therefore, if a request of a consuming application specifies the time T4 with T1<=T4<T2 as a validity constraint, then the returned result comprises the derived structure mentioned above.

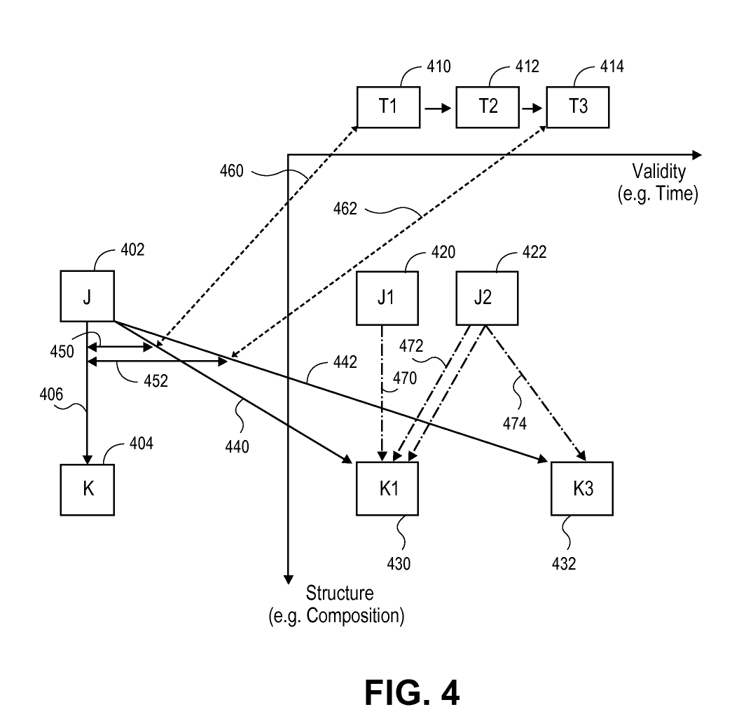

FIG. 4 is a diagram focusing on relation state elements, and their substitution, within an additional model of a validity dependent data set according to one embodiment of the invention. Within this model, there is a structural link 406 representing a validity dependent relation between two indices J 402 and K 404 representing two objects. The states 440 and 442 of this relation are from the object J 402 to the object states K1 430 and K3 432, respectively. The relation states 440 and 442 are mapped explicitly to their relation 406 (solid bidirectional arrows 450 and 452), and implicitly to the validity bounds T1 410 and T3 414 (dotted bidirectional arrows 460 and 462) which are representing the beginning of their validities, respectively. FIG. 4 further shows substitution of relation states. In detail, relation state 440 involving object J 402 can be substituted by derived relation states 470 and 472 resulting from substituting object J 402 by its object states J1 420 and J2 422. Respectively, the derived relation state 470 or 472 is valid beginning with the validity bound T1 410 or T2 412. Similarly, relation state 442 involving also object J 402 can be substituted by derived relation state 474 resulting from substituting object J 402 by all its object states J1 420 and J2 422. The derived relation state from J1 420 to K3 432 is not relevant as it cannot be valid before validity bound T3 414 due to the validity of K3 432, and then the validity of the derived relation state 474 is superior since J2 422 has replaced J1 420 from validity bound T2 412 on.

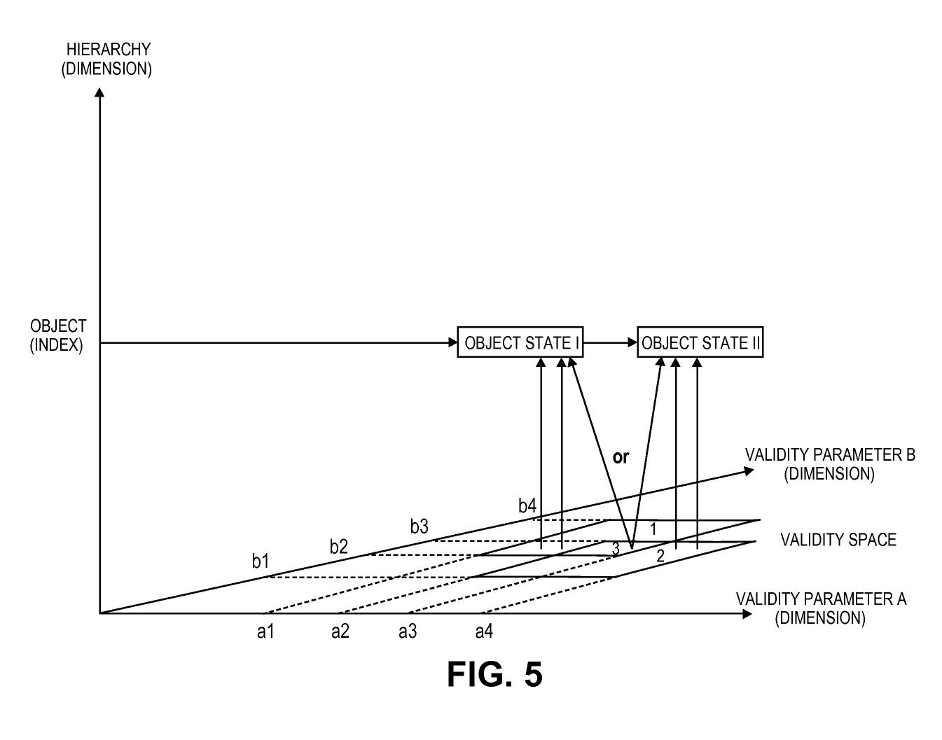

FIG. 5 is a dimensional diagram showing exemplary assignment of object states to a validity space consisting of dimensions for two validity parameters A and B. In this diagram, object state 1 and object state 2 exist in overlapping validity subspaces 1 and 2 respectively, where the overlap is subspace 3. In this example, the data model would define non-overlapping validity subspaces 1\3, 3 and 2\3. State 1 would be mapped to subspace 1\3 and state 2 would be mapped to subspace 2\3. It would be possible to map either state 1 or state 2 to layer 3. However, the assignment may also be left open until a consuming application defines within this request, which state of the object is relevant for layer 3.

While embodiments of the invention are discussed above in the context of flow diagrams reflecting a particular linear order, this is for convenience only. In some cases, various operations may be performed in a different order than shown or various operations may occur in parallel. It should also be recognized that some operations described with respect to one embodiment may be advantageously incorporated into another embodiment. Such incorporation is expressly contemplated.

Elements of embodiments of the present invention may also be provided as a machine-readable medium for storing the machine-executable instructions. The machine-readable medium may include, but is not limited to, flash memory, optical disks, compact disks read only memory (CD-ROM), digital versatile/video disks (DVD) ROM, random access memory (RAM), erasable programmable read-only memory (EPROM), electrically erasable programmable read-only memory (EEPROM), magnetic or optical cards.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

1. A method comprising:
defining a set of dimensions for a validity dependent data set;
associating at least a first dimension, belonging to the set of dimensions, with a validity independent structure of the data set;
associating at least a second dimension, belonging to the set of dimensions and being different from the first dimension, with one or more validity constraints effective for the data set;
retrieving, in a processor, the validity dependent data set and its association with the set of dimensions;
generating, in the processor, a plural dimensional model of the retrieved data; and
responding, from the processor, to a request of a consuming application with information derived from the plural dimensional model.

2. The method of claim 1, wherein an aspect represents a unique list of data fields and wherein the validity independent structure of the data set comprises at least one of:
objects of one or multiple aspects;
relations between objects of one or multiple aspects;
components of one or multiple aspects, a component containing objects and relations; or
features of one or multiple aspects, a feature being a subordinate characteristic to an object, a relation, a component or another feature.

3. The method of claim 1 wherein associating the first dimension comprises:
defining a first index for a validity independent existence of an object and assigning the first index uniquely to the first dimension; and
defining a first link for a validity independent existence of a relation between objects; and
wherein associating the second dimension comprises:
defining a second index for a bound of a validity constraint effective for at least a part of the data set and assigning the second index uniquely to the second dimension; and
defining a second link for an order between two validity indices of the second dimension.

4. The method of claim 1 wherein associating the first and the second dimension comprise:
at least one of mapping a state of an object to a first index representing the object or mapping a state of a relation to a first link representing the relation; and
mapping a state of an object or a relation to a second index which represents a bound of a validity constraint effective for the state.

5. The method of claim 1 wherein generating comprises:
creating an element for each dimension, each index and for at least one of each object state or each relation state.

6. The method of claim 5 wherein the data set is hierarchical further comprising:
enabling navigation between elements of the model to permit the processor to directly or indirectly access all elements.

7. The method of claim 5 wherein the data set is hierarchical and wherein responding comprises:
substituting at least one of:
a component by all objects and relations contained by it;
a dimension by all indices assigned to it;
an index by all states mapped to it;
a link by all states mapped to it; and
a relation state involving at least one object by derived relation states at least resulting from substituting the object by all its object states.

8. The method of claim 1 wherein responding comprises:
returning one or more elements of the model satisfying a set of constraints specified in the request.

9. The method of claim 8 wherein returning comprises:
considering a first element from the model not satisfying the set of constraints;
substituting one or more other elements for the first element to yield a set of elements satisfying the set of constraints.

10. The method of claim 7 further comprising:
limiting the substituting based on one or more constraints in the request.

11. A system comprising:
a consuming application;
a database containing a validity dependent data set; and
a processor to retrieve the data set, associate at least a first dimension with a validity independent structure of the data set and at least a second dimension with a validity constraint of the data set, generate a plural dimensional model of the data set, and to respond to requests from the consuming application with data derived from the model and satisfying a set of constraints supplied by the consuming application.

12. The system of claim 11 wherein the processor comprises:
a consumption interface;
a modeler; and
a retrieval interface.

13. The system of claim 12 wherein the modeler comprises:
a navigation module to permit the processor to access all elements of the model; and
a substitution module to permit substitution of:
a component by all objects and relations contained by it;
a dimension by all indices assigned to it;
an index by all states mapped to it;
a link by all states mapped to it; and
a relation state involving at least one object by derived relation states at least resulting from substituting the object by all its object states.

14. A computer readable medium having instructions stored thereon that when executed by a processor cause the processor to:
retrieve a validity dependent data set;
associate the data set with a set of dimensions, at least a first dimension with a validity independent structure of the data set, and at least a second dimension with a validity constraint of the data set; and
respond to requests of a consuming application with information derived from the data set retrieved.

15. The computer readable medium of claim 14 wherein the instructions further cause the processor to:
at least one of map a state of an object to the index representing the object or map a state of a relation to the link representing the relation;
and
map a state of an object or a relation to an index which represents a bound of a validity constraint effective for the state.

16. The computer readable medium of claim 14 wherein the instructions causing the processor to respond cause the processor to:
consider a first element from the model not satisfying a set of constraints specified in a request; and
substitute one or more other elements for the first element to yield a set of elements satisfying the set of constraints.
